(19) United States
(12) Patent Application Publication
(10) Pub. No.: US 2006/0281504 A1
(43) Pub. Date: Dec. 14, 2006

(54) Carrying case for a cell phone wire reel combination

(76) Inventor: Elaina M. Pint, Brandon, FL (US)

Correspondence Address: Eliana M. Pint, 716 Oakgrove Dr. #135, Brandon, FL, 33510, US

(21) Appl. No.: 11/149,705

(22) Filed: Jun. 13, 2005

(51) Int. Cl. H04M 1/00

(52) U.S. Cl. 455/575.6; 455/575.8

(57) ABSTRACT

A cell phone wire reel combination is carried either on a waistline of a user or substantially anywhere in a moving vehicle. The wire reel has a wire therein that may be unwound to place an ear plug microphone combination into an ear of a user. The wire reel is removably attached to the cell phone carrying case by elastic straps. The elastic straps are either sewn to a soft carrying case or glued to a rigid carrying case. The elastic straps are arranged in a V-shaped configuration to firmly hold the wire reel in place or to aid in an easy removal therefrom.

### FIELD OF THE INVENTION

Cell phones are in wide use not only in this country but all over the world. There are many devices to carry the cell phone on a body of a person or in a vehicle.

### BACKGROUND OF THE INVENTION

Cell phones are carried in pockets of trousers or in handbags. They are also carried in cloth bags which are attached to a waistline of the user. They are also carried in hardened cases which are also attached to a waistline or a belt of a user. The cell phone may be used anywhere where desired. The cell phones can also receive messages at most unexpected times or location. The use of the cell phone may also be accomplished while riding in a moving vehicle. As a passenger this use is quite allright but many persons use the cell phone while driving. This practice is quite dangerous because it detracts the driver's attention from a full time observation of the traffic around the person or from observations of traffic signs or signals.

There are quite a few states that prohibit a driver in a moving vehicle from using the cell phone while the cell phone is in their hand.

Various devices have been developed to ease the use of a cell phone under certain conditions such as while driving a vehicle. Extension cords have been provided that will at one end plug into a cell phone while the other end has an earplug attached thereto that will plug into the ear of the person using the phone. The earplug has a rigid extension thereon that extends into the vicinity of the mouth of the user to thereby enable a conversation without having to hold the cell in one's hand. The extension cord has further been developed to be stored in a case having a wind-up spring therein so that the extension cord can be wound when not in use. The wind-up case itself has a clip thereon to enable the same to be carried on a belt or on a waistline of the user. Thus, there are two different items that have to be carried by a user of a cell phone on a belt or on a waistline or, if not possible, in a hand bag or other carrying items. The inventive concept combines both of those items mentioned above into one unit.

### BRIEF DESCRIPTION OF THE INVENTION

The inventive concept envisions elastic straps to be attached to any cell phone carrier such as, a bag made out of cloth as is being used to carry a small camera. The carrying case could also be made out of a rigid material including a form fitting slide, whereby the cell phone will have to snap fit when inserted into the case. With other words, it would apply and could be used with any carrying case presently on the market.

### BRIEF DESCRIPTION OF THE FIGS. OF THE DRAWINGS

FIG. 1 is a perspective view of a cell phone contained in a carrying case with the spool case attached thereto;

FIG. 2 is a perspective view of the elastic bands that hold the spool case;

FIG. 3 is a side view of the elastic bands;

FIG. 4 is a rear view of the elastic bands.

### DETAILED DESCRIPTION OF THE INVENTION

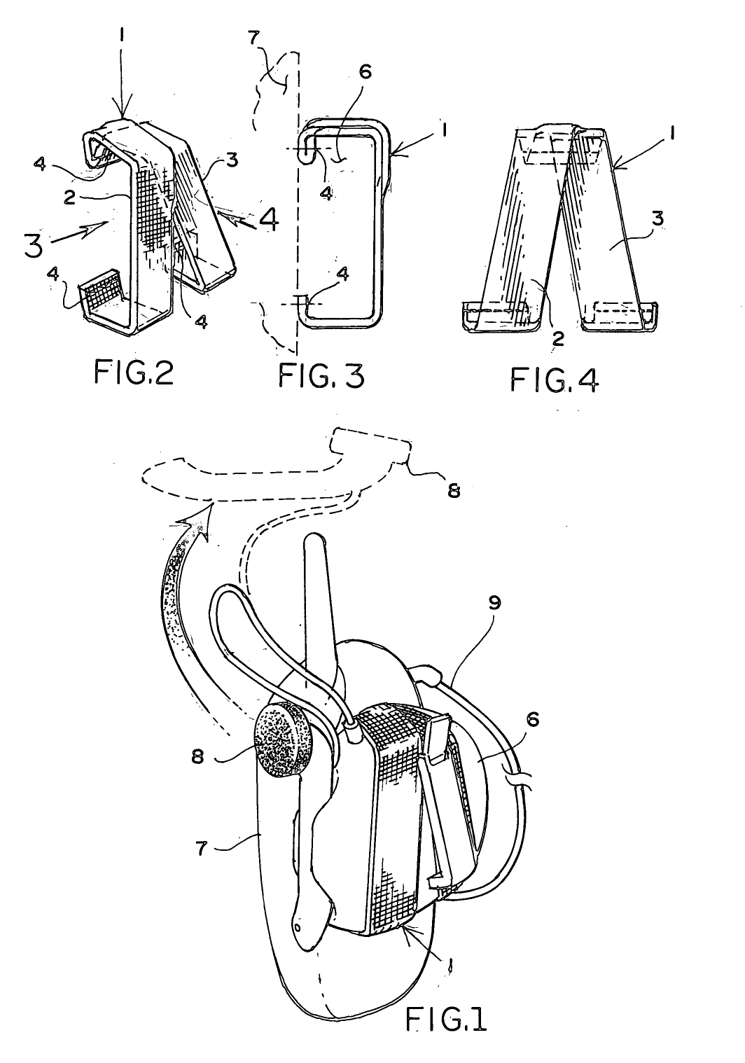

FIG. 1 is a perspective view of the cell phone as it is contained in a carrying case which is normally carried in a carrying case. The cell phone can be seen at 7. The cell phone is easily accessible because a flap (not shown) holds the phone within the case. In many cell phones there is a receptacle into which to plug an ear phone 8 with an extension thereon to act as a microphone. This arrangement assures a hands-free operation while the cell phone is in use. In many instances, the connecting wire between the cell phone and ear-microphone is contained in a wind-up reel and is carried somewhere else on the body of the user such as at waistline or belt, for example. This wind-up reel has its own clip thereon to be fastened to the belt of the user. These different items, that are carried on a belt or on the waistline, can be quite cumbersome'and the different wires in connection therewith can get tangled up. The inventive concept solves this problem be removable attaching the reel to the cell phone carrier or case. This is accomplished by attaching at least two elastic straps 2 and 3 to the carrying case of the cell phone. As shown in FIGS. 2-4, a single elastic strap is doubled back upon itself to form a central point which is then sewn to the carrying case at 4 at an upper position thereof. The elastic straps are then continued downwardly, are spread apart to form a V and the separated ends are then each sewn to the carrying case, again at 4, at a lower position thereof. This arrangement provides a secure attaching of the reel 6 to the carrying case.

As mentioned above, there are also known hard or rigid carrying cases to be used for attaching the cell phone to a waistline of the user. In this case, the ends of the elastic straps would have be fastened to the carrying case by either gluing or by rivets or staples. Experiments have shown that parallel elastic straps did not provide a secure attaching of the reel 6 to the carrying case. The three point attachment proved to be much more efficient in holding the reel 6 and also in removing it because of V-shaped opening at the bottom. This way, there is only one wire emanating from the reel and leading to the earplug-microphone. The length of it is still controlled by reel 6. It all depends on the location where the cell phone carrying case is attached at the waistline. The inventive arrangement also assures that the cell-phone-reel combination does not have be carried on a waistline of a user when operating a vehicle. The combination can be placed substantially anywhere in the vehicle because the wire from the reel to the earplug-microphone element is long enough to assure a hands-free operation.

What I claim is:

1. A cell phone wire reel combination including a carrying case for said cell phone and means for removably attaching said wire reel to said carrying case of said cell phone, whereby a wire line may be unreeled from said wire reel and an end of said wire carrying an ear plug-microphone may be installed in an ear of a user.

2. The cell phone wire reel combination of claim 1, wherein said means for removably attaching comprises elastic straps including means for attaching said elastic straps to said carrying case.

3. The cell phone wire reel combination of claim 2, wherein said elastic straps are sewn to said carrying case.

4. The cell phone wire reel combination of claim 2, wherein said elastic straps are glued to said carrying case.

5. The cell phone wire reel combination of claim 2, wherein said elastic straps are arranged on said carrying case in a V-shaped configuration.
